(19) United States
(12) Patent Application Publication
(10) Pub. No.: US 2015/0310403 A1
(43) Pub. Date: Oct. 29, 2015

(54) ESTABLISHMENT SERVICE RATING VIA TIP AMOUNTS

(71) Applicant: International Business Machines Corporation, Armonk, NY (US)

(72) Inventors: Li Chen, Cary, NC (US); Henri F. Meli, Cary, NC (US); David M. Stecher, Durham, NC (US); Lin Sun, Morrisville, NC (US)

(73) Assignee: International Business Machines Corporation, Armonk, NY (US)

(21) Appl. No.: 14/260,323

(22) Filed: Apr. 24, 2014

(51) Int. Cl. G06Q 20/10

(52) U.S. Cl. CPC G06Q 20/102

(57) ABSTRACT

According to one aspect of the present disclosure, a method and technique for establishment service rating via tip amounts is disclosed. The method includes: determining, by a client computing system, a total tip amount corresponding to a plurality of transactions at an establishment; determining a total party size representing a total quantity of consumers receiving services from the establishment corresponding to the plurality of transactions; computing an average tip per person value based on the total tip amount and the total party size, the average tip per person value anonymous to the consumers; and forwarding, by the client computing system to a rating service for online display by the rating service, the average tip per person value corresponding to the establishment for online access and viewing by other consumers.

### BACKGROUND

Review systems are getting more and more important as consumers use such systems as a reference to make purchasing decisions. Oftentimes, consumers will utilize the reviews of other consumers systems to determine if there are any reviews associated with a particular product/service the consumer is interested in purchasing. The consumer may then make a purchasing decision based on these prior reviews of other consumers.

### BRIEF SUMMARY

According to one aspect of the present disclosure a method and technique for establishment service rating via tip amounts is disclosed. The method includes: determining, by a client computing system, a total tip amount corresponding to a plurality of transactions at an establishment; determining a total party size representing a total quantity of consumers receiving services from the establishment corresponding to the plurality of transactions; computing an average tip per person value based on the total tip amount and the total party size, the average tip per person value anonymous to the consumers; and forwarding, by the client computing system to a rating service for online display by the rating service, the average tip per person value corresponding to the establishment for online access and viewing by other consumers.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a computing environment in which illustrative embodiments of a system for establishment service rating via tip amounts according to the present disclosure may be implemented; and

FIG. 4 is a flow diagram illustrating an embodiment of a method for establishment service rating via tip amounts according to the present disclosure.

### DETAILED DESCRIPTION

Embodiments of the present disclosure provide a method, system and computer program product for establishment service rating via tip amounts. Embodiments of the present disclosure automatically and anonymously collect tip information and use that tip information to rate and/or compare establishments. For example, in some embodiments, the average tip amount per person may be used to rate an establishment and compare the establishment to other similar lines of business to determine the service associated with the tip/establishment. The tip amount oftentimes relates directly to the satisfaction of the consumer with the establishment that provided the product/service. Embodiments of the present disclosure also enable the anonymous leveraging of payment information to determine the frequency of return of the same customers to indicate the satisfaction level of the customers with the particular establishment. For example, in some embodiments, the method and technique includes: determining, by a client computing system, a total tip amount corresponding to a plurality of transactions at an establishment; determining a total party size representing a total quantity of consumers receiving services from the establishment corresponding to the plurality of transactions; computing an average tip per person value based on the total tip amount and the total party size, the average tip per person value anonymous to the consumers; and forwarding, by the client computing system to a rating service for online display by the rating service, the average tip per person value corresponding to the establishment for online access and viewing by other consumers.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

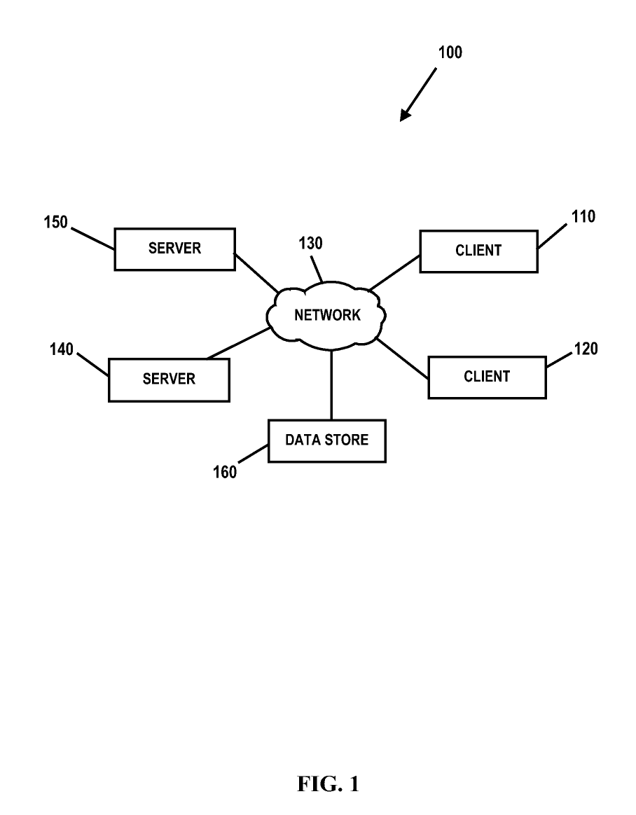

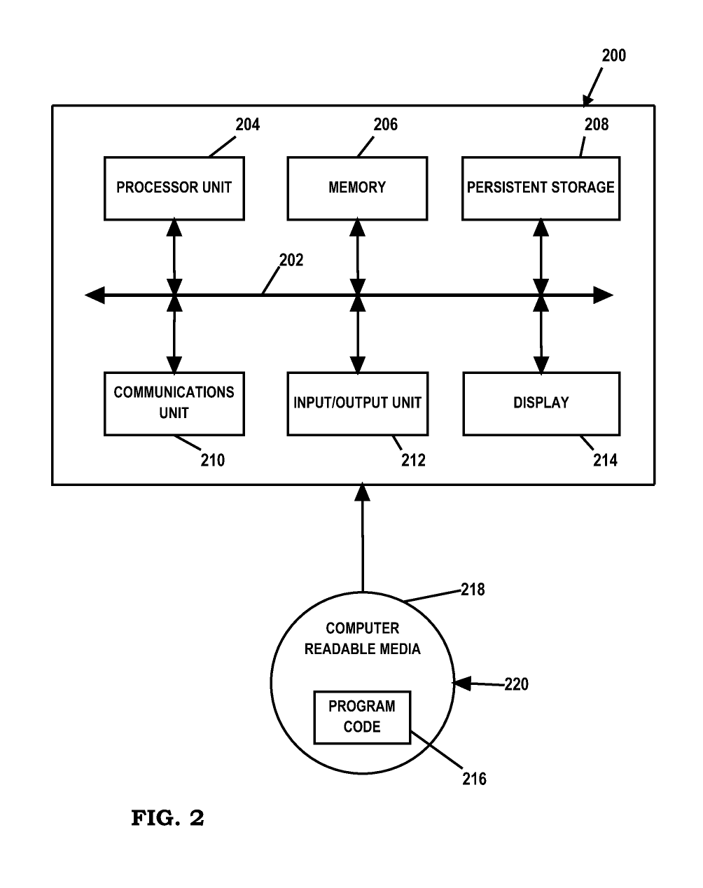

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. Server 140 and server 150 may be, for example, IBM® Power Systems™ servers. In addition, clients 110 and 120 connect to network 130. Clients 110 and 120 may be, for example, personal computers or network computers. In the depicted example, server 140 provides data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 and/or server 140 in which an embodiment of a system for establishment service rating via tip amounts according to the present disclosure may be implemented. In this embodiment, data processing system 200 includes a bus or communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

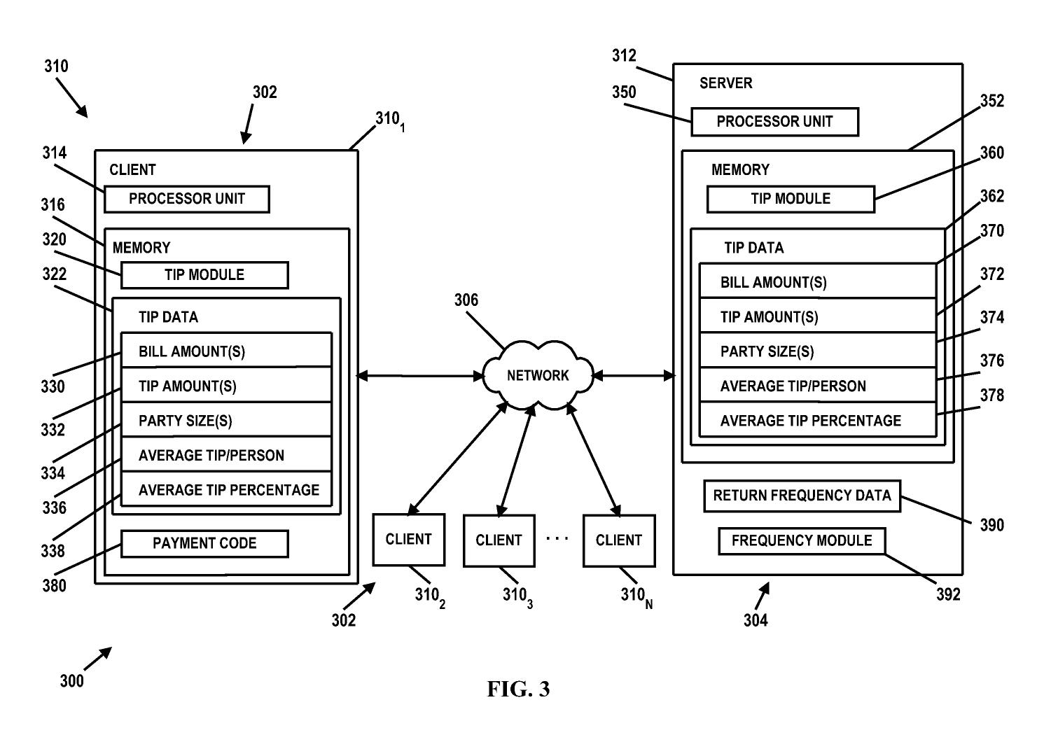

FIG. 3 is a diagram illustrating a computing environment in which an embodiment of a system 300 for establishment service rating via tip amounts according to the present disclosure may be implemented. In the illustrated embodiment, system 300 includes one or more establishments 302 connected to a rating service 304 via a network 306 (e.g., such as network 130). Each establishment 302 may include a client 310 (e.g., client 310₁₋ₙ) and rating service 304 may include a server 312 such as, but not limited to, client 110 and/or server 140. Clients 310 may comprise any type of computing device and/or data processing system associated with an establishment such as, but not limited to, a desktop computer, laptop computer, tablet computer, portable telephone used to receive payments, or other type of portable or non-portable device. Clients 310 may each be configured similarly or have various configuration differences. For ease of description and illustration, client 310₁ will be described; however, it should be understood that clients 310₂₋ₙ may be configured to provide all or part of the functionality of client 310₁. In the context of this disclosure, an “establishment” 302 may comprise any entity, business and/or or product/service provider where a tip or gratuity may be provided/paid in addition to, or part of, payment by a consumer for such product/service. For example, an establishment 302 may comprise a restaurant, limousine service, retailer, concierge, cleaning service, etc. Rating service 304 may comprise a computing/hosting environment, site or service such as, but not limited to, an online or web-based social network, comparator service, bulletin board, blog, or other type of site that may display, rate and/or rank various types of establishments 302. For example, service 304 may categorize and/or group together similar types of establishments 302 (e.g., offering the same or similar products/services, similar establishments based on size or level of offering (e.g., casual dining versus fine dining), etc.) and provide/display various types of information enabling a user/consumer to review such information for the purpose of evaluating such establishments 302.

In the illustrated embodiment, client 310₁ includes a processor unit 314 and a memory 316. In FIG. 3, memory 316 includes a tip module 320 for gathering and/or computing various tip-related information and forwarding such information to server 312. Tip module 320 may be implemented in any suitable manner using known techniques that may be hardware-based, software-based, or some combination of both. For example, tip module 320 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

In the illustrated embodiment, memory 316 also includes tip data 322. Tip data 322 may comprise any type of information associated with a product/service offering of an establishment. Such information may correspond to a single transaction or be based on multiple transactions (e.g., gathered and/or computed over time covering multiple transactions over some particular time period). For example, in the illustrated embodiment, tip data 322 includes a bill amount(s) 330, a tip amount(s) 332, a party size(s) 334, a tip per person amount(s) 336 and a tip percentage(s) 338. It should be understood that other types of tip-related information may also be gathered and/or computed. Bill amount 330 may represent a total amount of a bill or charge for a particular product/service (e.g., less any tip/gratuity). Bill amount 330 may represent an amount corresponding to a single purchasing transaction or many transactions (e.g., a total amount of all bills/purchase transactions occurring over some time period, such as a day/week). Tip amount 332 may represent the tip/gratuity left/added by a consumer of such product/service. Tip amount 332 may represent a tip corresponding to a single purchasing transaction or many transactions (e.g., a total amount of tips occurring over some time period, such as a day/week, corresponding to an associated number of transactions). Party size 334 may represent a quantity of persons/consumers that received the product/service from the establishment 302 (e.g., if applicable to the particular type of product/service (e.g., the number of persons attending a dining experience)). Thus, for example, a party size may represent a larger quantity of consumers than a quantity of consumers that actually paid for the product/service. As an example, consider a dining experience. Although a single consumer may pay the establishment for the dining service, the number of diners may have been five (i.e., a party size of five).

Tip/person 336 may represent a computed value of the amount of the tip divided by a quantity of persons/consumers receiving the product/service (e.g., the tip amount 332 divided by party size 334). Tip/person 336 may be computed for a single purchasing transaction or many transactions (e.g., an average tip per person based on a total amount of all bills/purchase transactions occurring over some time period, such as a day/week, divided by a total amount of all tips associated with the corresponding number of transactions). Tip percentage 338 may be a computed value representing the amount of the tip/gratuity as a portion of the bill amount 330 (e.g., tip amount 332 divided by bill amount 330×100). Tip percentage 338 may be computed based on a single purchasing transaction or many transactions (e.g., the total tip amount received over some time period, such as a day/week, for a certain number of transactions divided by a total amount of all bills/purchase transactions for such transactions, multiplied by one hundred).

In some embodiments, various types of tip data 322 may be automatically gathered (e.g., as part of an electronic/automated payment system) and/or may be manually entered into client 310. In some embodiments, tip module 320 may compute various types of tip data 322 and/or forward certain types of tip data 322 to server 312 where server 312 may compute various types of tip-related information. For example, in the illustrated embodiment, server 312 also includes a processor unit 350 and a memory 352. In FIG. 3, memory 352 includes a tip module 360 and tip data 362. Tip data 362 may include a bill amount(s) 370, a tip amount(s) 372, a party size(s) 374, a tip per person amount(s) 376 and a tip percentage(s) 378. Bill amount 370, tip amount 372, party size 374, tip per person amount 376 and tip percentage 378 may comprise information similar to tip data 322 gathered by a particular client 310 and/or computed by tip module 360. For example, in some embodiments, instead of computing tip/person 336 and/or tip percentage 338 by client 310, client 310 may forward to server 312 bill amount 330, tip amount 332 and/or party size 334 (represented as bill amount 370, tip amount 372 and party size 374 in FIG. 3). Tip module 360 may then derive/compute a value representing tip/person 376 and/or tip percentage 378. Tip module 360 may be implemented in any suitable manner using known techniques that may be hardware-based, software-based, or some combination of both. For example, tip module 360 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

Tip data 322 may be communicated from clients 310 to server 312 or gathered by server 312 from clients 310 in real time, near real time, or according to some predetermined schedule. For example, in some embodiments, tip data 322 may be forwarded to server 312 as transactions are completed at a client 310, at the end of a business day/weekend/week/month, after a certain quantity of transactions are completed, or according to some other schedule.

Tip module 360 may be configured to derive and post/display certain types of tip data 362 in real time, near real time or according to some predetermined schedule. For example, in some embodiments, tip module 360 may be configured to compute and/or display tip/person 376 and/or tip percentage 378 in response to receiving tip data 322 from a particular client 310. In other embodiments, tip module 360 may compute and/or display certain types of tip data 362 according to a predetermined schedule (e.g., a schedule corresponding with the communication of tip data 322 from clients 310). As indicated above, tip data 362 may be posted/displayed in connection with the submitting establishment 302. Establishments 302 may register with service 304 to provide tip data 322 and have such establishment 302's tip data 322/362 displayed by service 304 for viewing/comparing by users logging onto the service 304. As indicated above, the establishments 302 may be grouped and/or categorized by service 304 according to the type of product/service provided by the establishment 302 or otherwise. In some embodiments, average tip/person 336 and average tip percentage 338 values may be determined/derived by clients 310 and/or server 312 for display by rating service 304. For example, in some embodiments, client 310, at the conclusion of a particular day/week/month/etc., may compute the average tip per person 336 value and/or an average tip percentage 338 value based on a number of transactions and forward the average tip information to rating service 304.

In some embodiments, rating service 304 may also post/display a quantity of consumers receiving products/services at a particular establishment 302 for a particular time period. For example, in some embodiments, client 310 may compute a total party size 334 occurring over some time period (e.g., day/week/month/etc.) and forward the total party size 334 information to rating service 304, where rating service 304 may post/display such information indicating a quantity of consumers receiving products/services from a particular establishment over some designated time period. Thus, for a dining establishment, for example, rating service 304 may post/display a quantity of consumers that dined at a particular restaurant over some time period, thereby indicating to other consumers the popularity of the restaurant.

In some embodiments, system 300 may be configured to track and/or display the frequency of returning consumers to a particular establishment 302. For example, in the illustrated embodiment, memory 316 also comprises a payment code 380. Payment code 380 may comprise a hash code generated from a credit/bank card number used by a consumer to pay for a product/service at a particular establishment 302. The payment code 380 is an anonymous code that may then be used to determine and/or calculate the frequency of the returning of the consumer to the particular establishment 302. For example, a subsequent visit by the consumer to the establishment 302 and use of the same credit/bank card, the calculation of the payment code 380 may be computed and compared against previously generated/stored payment codes to determine whether the consumer is a repeat customer and to determine a frequency of return to the establishment by the consumer. Payment codes 380 may be calculated at client 310 and forwarded to server 312, where return frequency data 390 may be computed/derived for consumers to particular establishments 302. For example, in some embodiments, for security purposes, payment codes 380 may not be retained by clients 310 (e.g., in a same location where an algorithm used to generate the payment code 380 is stored). Generated payment codes 380 may be forwarded to server 312 and stored thereby such that a frequency module 392 on server 312 may compare the received code 380 to previous codes 380 received from the particular establishment 302 and determine/identify returning consumers based on matching codes 380. The payment codes 380 may thereafter be deleted/purged by client 310. The frequency data 390 may then be posted/displayed by service 304 for the corresponding establishment 302. Frequency module 392 may be implemented in any suitable manner using known techniques that may be hardware-based, software-based, or some combination of both. For example, frequency module 392 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

It should be understood that in some embodiments, the payment codes 380 may be retained by client 310 and used by client 310 to determine return frequency data 390 for particular consumers. For example, in some embodiments, frequency module 392 may instead be located on client 310 and used by client 310 to compare a current code 380 to previously generated codes 380 to identify consumers that have purchased goods/services at the particular establishment 302 previously. Client 310 may compute the corresponding frequency data 390 and forward such data 390 to service 304 for display thereby.

Thus, current online rating systems rely on a particular consumer accessing, writing and posting a review. An insufficient quantity of reviews may result in a biased overall review, especially for local/small businesses/establishments where only a small number of consumers may visit the establishment and an even smaller number may post a review. Additionally, consumers tend to rate items that are either extremely favored or extremely disfavored (but not something in between). Further, reviews that are outdated may not be useful at all.

Embodiments of the present disclosure automatically and anonymously collect tip information and use that tip information to rate and/or compare establishments. For example, in some embodiments, the average tip amount per person may be used to rate an establishment and compare the establishment to other similar lines of business to determine the service associated with the tip/establishment. The tip amount oftentimes relates directly to the satisfaction of the consumer with the establishment that provided the product/service. Embodiments of the present disclosure also enable the anonymous leveraging of payment information to determine the frequency of return of the same customers to indicate the satisfaction level of the customers with the particular establishment.

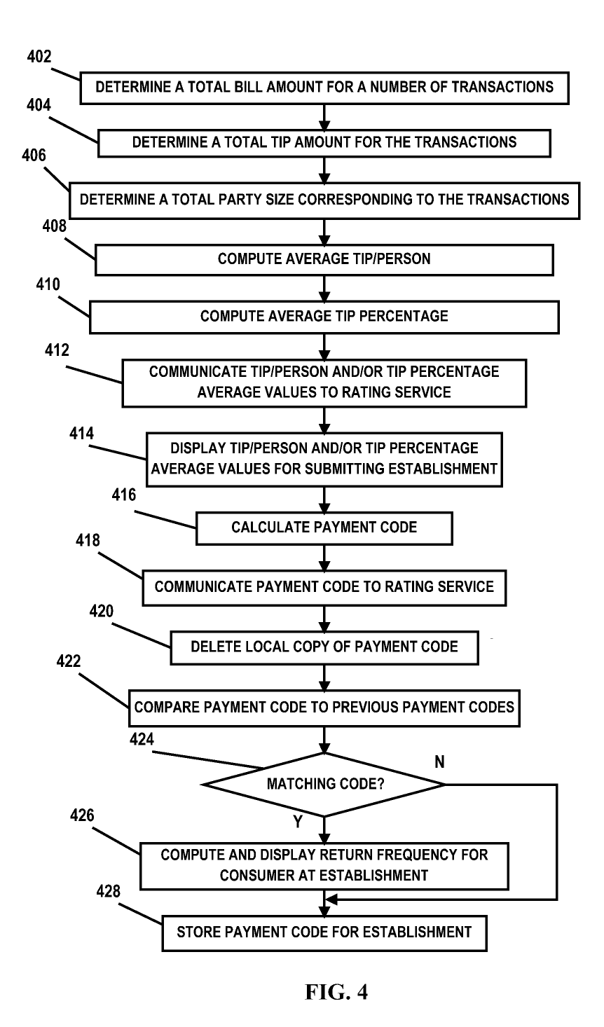

FIG. 4 is a flow diagram illustrating an embodiment of a method for establishment service rating via tip amounts according to the present disclosure. The method begins at block 402, where a total bill amount 330 is received/determined for some quantity of transactions (e.g., by client 310 and/or server 312). At block 404, a total tip amount 332 is received/determined for the corresponding quantity of transactions. At block 406, a total party size 334 is received/determined corresponding to the number of transactions (e.g., a quantity of consumers that may have purchased and/or participated the receipt of a product/service provided by an establishment). At block 408, an average tip/person 336 value is computed for the corresponding number of transactions. At block 410, an average tip percentage 338 based on the total tip amount 332 and the total bill amount 330 is computed for the corresponding quantity of transactions. As described above, in some embodiments, the average tip/person and/or the tip percentage values may be computed at client 310 or at server 312 of rating service 304.

At block 412, the average tip/person 336 and/or the average tip percentage 338 is communicated to rating service 304. As described above, in some embodiments, bill amount 330, tip amount 332 and/or party size 334 may be communicated to rating service 304 for the computation by tip module 360 of a tip percentage or an amount of a tip per person values. At block 414, server 312 displays the average tip/person 336/376 and/or the average tip percentage 338/378 values for the particular establishment 302. At block 416, a payment code 380 may be computed by client 310 (e.g., by tip module 320 and/or another code/algorithm). At block 418, client 310 communicates the calculated payment code 380 to server 312, and at block 420, client 310 deletes a local copy of the payment code 380.

At block 422, frequency module 392 of server 312 may compare a received payment code 380 to previously received payment codes for the particular establishment. At block 424, a determination is made whether the received code 380 matches an existing or previously received/stored code 380 (e.g., thereby indicating that a particular consumer purchased goods/services at the particular establishment previously). If so, the method proceeds to block 426, where frequency module 392 computes and/or otherwise derives a frequency that the consumer has purchased goods/services at the particular establishment 302 and displays such information. For example, the code 380 may be stored with and/or contain metadata indicating the date/time of a transaction such that a date/time of a current code may be evaluated against previous dates/times to derive a frequency the consumer visited or made a purchase at the particular establishment. The method proceeds to block 428. Also, At decisional block 424, if no match is found, the method proceeds to block 428, where the received code 380 (and any associated date/time information of such transaction) may be stored by frequency module 392 for comparison against subsequent codes 380 received by service 304 for the particular establishment 302.

Thus, embodiments of the present disclosure automatically and anonymously collect tip information and use that tip information to rate and/or compare establishments. Embodiments of the present disclosure also enable the anonymous leveraging of payment information to determine the frequency of return visits of the same customers to indicate the satisfaction level of the customers with the particular establishment.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method, comprising:
determining, by a client computing system, a total tip amount corresponding to a plurality of transactions at an establishment;
determining a total party size representing a total quantity of consumers receiving services from the establishment corresponding to the plurality of transactions;
computing an average tip per person value based on the total tip amount and the total party size, the average tip per person value anonymous to the consumers; and
forwarding, by the client computing system to a rating service for online display by the rating service, the average tip per person value corresponding to the establishment for online access and viewing by other consumers.

2. The method of claim 1, further comprising:
determining, by the computing system, a total bill amount corresponding to the plurality of transactions;
computing an average tip percentage value based on the total bill amount and the total tip amount; and
forwarding, by the client computing system to the rating service for online display by the rating service, the average tip percentage value corresponding to the establishment for online access and viewing by other consumers.

3. The method of claim 1, further comprising forwarding, by the client computing system to the rating service for online display by the rating service, the total party size corresponding to the establishment for online access and viewing by other consumers.

4. The method of claim 1, further comprising:
computing, by the client computing system, an anonymous payment code corresponding to a first consumer of a first transaction of the plurality of transactions;
determining whether the payment code matches previous payment codes generated by the client computing system; and
responsive to the computed payment code matching at least one previous payment code generated by the client computing system, determining a frequency to the establishment for the first consumer based on the computed payment code and any previous payment codes corresponding to the first consumer.

5. The method of claim 4, further comprising computing the anonymous payment code by hashing a bank card number received from the first consumer for payment of the first transaction.

6. The method of claim 1, further comprising computing the average tip per person value based on a predetermined interval.

7. The method of claim 1, further comprising computing the average tip per person value based on an occurrence of a predetermined quantity of transactions.

8. A system, comprising:
a client computing system having a processor unit and a memory; and
a tip module executable by the processor unit to:
determine a total tip amount corresponding to a plurality of transactions at an establishment;
determine a total party size representing a total quantity of consumers receiving services from the establishment corresponding to the plurality of transactions;
compute an average tip per person value based on the total tip amount and the total party size, the average tip per person value anonymous to the consumers; and
forward, to a rating service for online display by the rating service, the average tip per person value corresponding to the establishment for online access and viewing by other consumers.

9. The system of claim 8, wherein the tip module is operable to:
determine a total bill amount corresponding to the plurality of transactions;
compute an average tip percentage value based on the total bill amount and the total tip amount; and
forward, to the rating service for online display by the rating service, the average tip percentage value corresponding to the establishment for online access and viewing by other consumers.

10. The system of claim 8, wherein the tip module is operable to forward, to the rating service for online display by the rating service, the total party size corresponding to the establishment for online access and viewing by other consumers.

11. The system of claim 8, further comprising a frequency module executable by the processor unit to:
compute an anonymous payment code corresponding to a first consumer of a first transaction of the plurality of transactions;
determine whether the payment code matches previous payment codes generated by the client computing system; and
responsive to the computed payment code matching at least one previous payment code generated by the client computing system, determine a frequency to the establishment for the first consumer based on the computed payment code and any previous payment codes corresponding to the first consumer.

12. The system of claim 11, wherein the frequency module is operable to compute the anonymous payment code by hashing a bank card number received from the first consumer for payment of the first transaction.

13. The system of claim 11, wherein the frequency module is operable to forward the frequency to the rating service for display thereby.

14. The system of claim 8, wherein the tip module is operable to compute the average tip per person value based on a predetermined interval.

15. A computer program product for establishment service rating via tip amounts, the computer program product comprising a computer readable storage medium having program instructions embodied therewith, the program instructions executable by a processor to cause the processor to perform a method comprising:
determining a total tip amount corresponding to a plurality of transactions at an establishment;
determining a total party size representing a total quantity of consumers receiving services from the establishment corresponding to the plurality of transactions;
computing an average tip per person value based on the total tip amount and the total party size, the average tip per person value anonymous to the consumers; and
forwarding, to a rating service for online display by the rating service, the average tip per person value corresponding to the establishment for online access and viewing by other consumers.

16. The computer program product of claim 15, wherein the computer readable program code is configured to cause the processor to:
determine a total bill amount corresponding to the plurality of transactions;
compute an average tip percentage value based on the total bill amount and the total tip amount; and
forward, to the rating service for online display by the rating service, the average tip percentage value corresponding to the establishment for online access and viewing by other consumers.

17. The computer program product of claim 15, wherein the computer readable program code is configured to cause the processor to forward, to the rating service for online display by the rating service, the total party size corresponding to the establishment for online access and viewing by other consumers.

18. The computer program product of claim 15, wherein the computer readable program code is configured to cause the processor to:
compute an anonymous payment code corresponding to a first consumer of a first transaction of the plurality of transactions;
determine whether the payment code matches previous payment codes generated by the client computing system; and
responsive to the computed payment code matching at least one previous payment code generated by the client computing system, determine a frequency to the establishment for the first consumer based on the computed payment code and any previous payment codes corresponding to the first consumer

19. The computer program product of claim 18, wherein the computer readable program code is configured to cause the processor to compute the anonymous payment code by hashing a bank card number received from the first consumer for payment of the first transaction.

20. The computer program product of claim 18, wherein the computer readable program code is configured to cause the processor to forward the frequency to the rating service for display thereby.
